(19) United States
(12) Patent Application Publication
(10) Pub. No.: US 2026/0004538 A1
(43) Pub. Date: Jan. 1, 2026

(54) DYNAMIC CONTROL OF DIGITAL ASSETS

(71) Applicant: Sphere Research Limited, London (GB)

(72) Inventor: David PARKER, London (GB)

(21) Appl. No.: 19/322,473

(22) Filed: Sep. 8, 2025

Related U.S. Application Data
(63) Continuation of application No. PCT/GB2024/050553, filed on Feb. 29, 2024.

(30) Foreign Application Priority Data
Mar. 7, 2023 (GB) 2303319.4

(51) Int. Cl. G06T 19/20; G06T 15/20

(52) U.S. Cl. CPC G06T 19/20; G06T 15/20; G06T 2200/24; G06T 2219/2004

(57) ABSTRACT

A computer-implemented method includes providing data representing respective instances of a three-dimensional environment comprising a plurality of digital assets to a first one or more user devices. The method includes receiving, from the first one or more user devices, input data indicating user actions performed at the first one or more user devices while the respective instances of the three-dimensional environment are rendered via the first one or more user devices, the input data indicating respective locations in the three-dimensional environment associated with the performing of the user actions. The method includes determining, in dependence on the indicated user actions and locations in the three-dimensional environment, a spatial configuration and/or an order for the plurality of digital assets, for use in rendering the plurality of digital assets via a second one or more user devices.

### CROSS-REFERENCE TO RELATED APPLICATIONS

This application is a continuation under 35 U.S.C. § 120 of International Application No. PCT/GB2024/050553, filed Feb. 29, 2024, which is claims priority to UK Application No. GB 2303319.4, filed Mar. 7, 2023, under 35 U.S.C. § 119 (a). Each of the above-referenced patent applications is incorporated by reference in its entirety.

### TECHNICAL FIELD

The present invention relates to controlling a spatial configuration and/or ordering of digital assets for rendering in a digital environment via a set of user devices.

### BACKGROUND

Many web pages include elements that vary in dependence on user browsing data. For example, a retail website may provide a recommendation of a product to a user based on the products recently viewed or bought and products bought by other users with similar browsing activity. Nevertheless, the overall structure and design of a web page is static and designed by a web designer.

### SUMMARY

According to a first aspect, there is provided a computer-implemented method, a data processing system comprising means for carrying out the computer-implemented method, and a computer program product (such as one or more non-transitory storage media) comprising instructions which, when the program is executed by a computer, cause the computer to carry out the computer-implemented method.

The computer-implemented method includes providing data representing respective instances of a three-dimensional environment comprising a plurality of digital assets to a first one or more user devices, receiving input data from the first one or more user devices indicating user actions performed at the first one or more user devices and indicating respective locations in the three-dimensional environment associated with the performing of the user actions while the respective instances of the three-dimensional environment are rendered via the first one or more user devices, and determining a spatial configuration and/or an order for the plurality of digital assets for use in rendering the plurality of digital assets via a second one or more user devices, in dependence on the indicated user actions and locations in the three-dimensional environment.

By determining a spatial configuration and/or order for the digital assets in response to input data indicating user actions, the rendering by the second one or more user devices can be dynamically controlled in response to user behaviour, either unilaterally, for individual users, or for cohorts of users. This enables certain effects or behaviours to be promoted in a data-driven fashion, such as longer browsing sessions, higher return rate of users, and/or more impressions of, or interactions with, particular assets or groups of assets.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically a user device and data processing system according to examples.

FIG. 2 shows schematically a system of multiple users and a data processing system according to examples.

FIG. 3A shows a rotate action performed on a three-dimensional model rendered from a perspective of a virtual camera in response to user input.

FIG. 3B illustrates the view from the virtual camera of FIG. 3A as the rotate action is performed.

FIG. 4A shows a zoom action performed on a three-dimensional model rendered from a perspective of a virtual camera in response to user input.

FIG. 4B illustrates the view from the virtual camera of FIG. 4A as the zoom action is performed.

FIGS. 5A-5C illustrate an example of updating data indicating relationships between digital assets.

FIGS. 6A-6D illustrate examples of rearranging digital assets for rendering in a 3D environment.

FIG. 7 is a flow chart representing a first method of rendering a 3D environment.

FIG. 8 is a flow chart representing a method of rendering a 3D environment.

### DETAILED DESCRIPTION

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

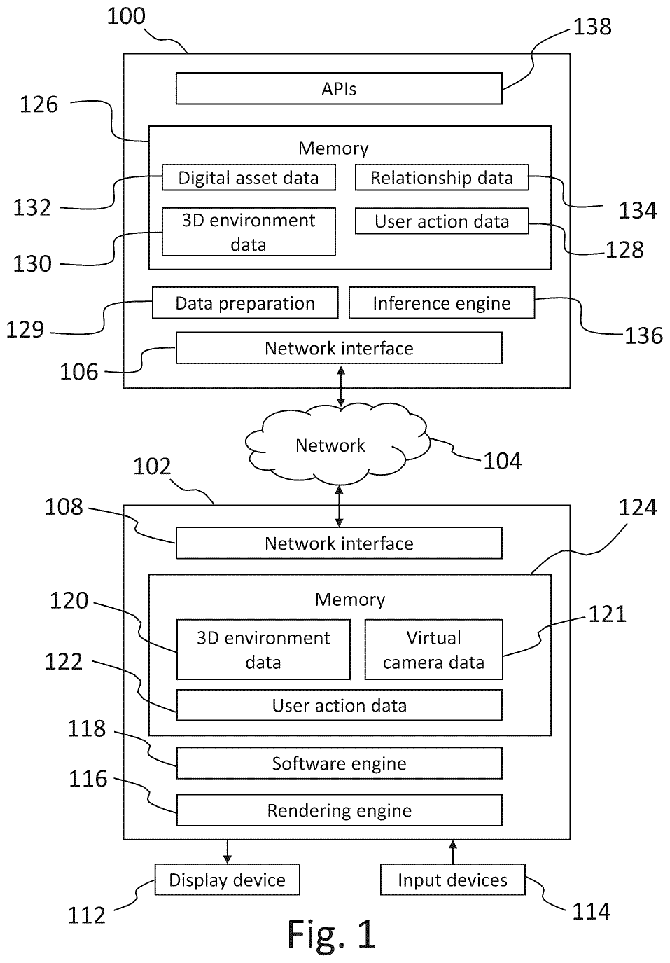

FIG. 1 schematically shows functional components of a data processing system 100 and a user device 102 arranged to communicate with one another over a network 104 via respective network interfaces 106, 108. The various functional components shown in FIG. 1 may be implemented for example using software, hardware, firmware or a combination thereof. The user device 102 can be any electronic device capable of outputting a video signal to a display device 112 in dependence on user input received from one or more input devices 114. For the purposes of the present disclosure, the video signal typically includes an instance of a three-dimensional environment rendered in real time by a rendering engine 116, for example using rasterization-based rendering techniques and/or ray tracing techniques. The user device 102 may be a personal computer (PC), a laptop computer, a tablet computer, a smartphone, a games console, a smart TV, a virtual/augmented reality headset with integrated computing hardware, or a server system arranged to provide cloud-based services to remote users. A server system may simultaneously render instances of the three-dimensional environment for multiple users.

The network interface 108 of the user device 102 includes communication means for transmitting and receiving data over the network 104. The communication means may include a wireless transceiver, a modem, and/or wired connection means. The network may include a core data packet network and, optionally, a radio access network. For example, the user devices 102 may transmit data over a Wi-Fi or cellular connection or over a wired ethernet connection. In particular, the user device 102 is arranged to transmit user action data to the data processing system 100 indicating user actions performed via the input devices 114. The user action data may be transmitted in batches, or as events corresponding to individual user actions. For example, the data processing system 100 may define an HTTPS GET endpoint, in which case an event may be transmitted to the data processing system 100 for each user action performed on one of the user devices 102 via an HTTPS GET request with query parameters containing the user action data. The data processing system 100 may be configured to respond to the requests with a 403-status code response. In this way, data encryption in transit may be supported.

The user device 102 further includes a software engine 118 responsible for managing the provision of 3D environment data 120 and virtual camera data 121 to the rendering engine 116, and for processing and storing user action data 122 generated from user actions performed via the input devices 114, as will be described in more detail hereafter. The 3D environment data 120, virtual camera data 121, and user action data 122 are stored in memory 124, which in the present disclosure encompasses both volatile and non-volatile memory and storage devices. It will be appreciated that the user device 102 may include additional functional components not shown in FIG. 1, for example additional output devices such as audio devices and/or haptic feedback devices.

The 3D environment data 120 includes code representing an instance of a three-dimensional environment. The three-dimensional environment may include one or more models of three-dimensional objects. Each model may include a polygon mesh formed of a set of connected polygons arranged to represent the surface of a three-dimensional structure, along with data for mapping textures and/or other digital objects to regions of the polygon mesh. A range of software libraries exist for generating a polygon mesh to represent a given geometrical structure, for example those defined in the Three .js JavaScript™ library or those used in the MeshLab™ software suite. The polygons of the model may be triangles, which can be used to generate a model of any surface and have the advantage that GPUs are optimised to perform computations based on triangles rather than other types of polygon, resulting in improved efficiency and speed of rendering. The 3D environment data 120 may also include data for controlling lighting, animation, and other effects.

The rendering engine 116 may be arranged to render the three-dimensional environment in dependence on the virtual camera data 121. For each rendered frame, the virtual camera data 121 may define values of one or more parameters of a virtual camera, which may be positioned within the three-dimensional environment. The parameters of the virtual camera may control a position and orientation of the virtual camera with respect to a given reference frame, along with an angle or angles subtended by a field of view of the virtual camera. Alternatively, the virtual camera may have a fixed position and orientation, and the virtual camera data 121 may instead control a position and orientation of one or more three-dimensional models relative to the virtual camera. The virtual camera data 121 thereby determines which digital assets in the three-dimensional environment are presented in a given frame, along with their respective positions, orientations, and scales.

The virtual camera may be controllable by user actions received via the input devices 114, meaning that the virtual camera data 121 may be updated in response to those user actions. Alternatively, the virtual camera data 12 may specify a predetermined path along which the virtual camera moves automatically. A given path may include one or more branch points at which the path splits into multiple branches, such that different branches may be accessed in dependence on user input or other factors. For example, when the virtual camera reaches a location in the three-dimensional environment corresponding to a branch point, a dialogue box may appear presenting the user with one or more options and the subsequent path of the virtual camera may be determined in dependence on a user selecting one of these options. For example, a dialogue box may appear while a field of view of the virtual camera is centred on a digital asset representing a book. The user may be presented with options to view other books by the same author, or on a related topic. If the user does not select one of these options, the virtual camera may continue on a default branch. If the user does select one of these options, the virtual camera may be routed onto a corresponding branch, which may involve moving or jumping a different location within the three-dimensional environment, or may involve jumping to a different three-dimensional environment altogether.

In another example, different branches at a given branch point may be allocated probabilities such that a given branch is accessed with a given probability, effectively creating a stochastic path through the three-dimensional environment. Branches may also be selected automatically in dependence on user- or device-specific factors. The virtual camera may be configured to switch between manual operation (in which the virtual camera is controlled by user actions) and automatic operation (in which the virtual camera moves along a predetermined path). For example, if the virtual camera remains stationary for a predetermined amount of time, the virtual camera may start to move automatically. On the other hand, a user may be permitted to take over control of the virtual camera at any time when the virtual camera is moving automatically.

The three-dimensional environment includes a set of digital assets. Each digital asset may include image data, video data, text data, audio data, three-dimensional model data, or a combination of any of these, and/or any other type of media that can be presented within the three-dimensional environment. The assets may for example represent products available for purchase in an online retail environment, and/or objects associated with a particular commercial or private entity.

The digital assets may be mapped to surfaces of one or more three-dimensional models within the three-dimensional environment, using texture mapping or other suitable techniques. During texture mapping, the assets are first arranged in a two-dimensional plane (referred to as a texture space), and an unfolded net of polygons forming a three-dimensional model is overlaid on the two-dimensional plane containing the assets. During rendering, points within a given polygon of the three-dimensional model may be coloured or “painted” by interpolating between the positions of the polygon's vertices in the two-dimensional plane, and sampling the colours of the assets appearing at the interpolated positions in the two-dimensional plane. The digital assets may be static or animated, and may be interactive, for example exhibiting certain behaviours in response to user input such as user selection of one or the assets or in dependence on the position and/or orientation of the virtual camera.

The 3D environment data 120 may be commonly provided as a web resource to multiple user devices, including the user device 102, and may be accessed via each of the user devices using a web browser or dedicated software application. The three-dimensional environment may for example be rendered within a <canvas> element of an html5 web page using the Three .js JavaScript application programming interface (API). The Three .js API has been developed specifically for generating animated three-dimensional graphics for rendering by a web browser, and make uses of the lower-level Web Graphics Library™ (WebGL) API which enables GPU-accelerated graphics rendering as part of a <canvas> element of a web page. In other examples, the three-dimensional environment may be rendered using a plug-in or dedicated software application.

Multiple user devices may render respective instances of the three-dimensional environment. For example, the user devices may render separate instances of the three-dimensional environment independently of one another, such that there is no direct interaction between the separate instances of the environment, and any change within one instance of the environment is not perceived by users interacting with a different instance of the environment. Alternatively, multiple user devices may communicate directly or indirectly with one another to render a common instance of the three-dimensional environment. In this case, changes made to the common instance of the environment by one user will be perceived by other users interacting with the same instance of the three-dimensional environment. For example, users may be associated with avatars or so-called “metahumans”, positioned and oriented in accordance with their respective virtual camera, enabling users to perceive other users within the same instance of the three-dimensional environment.

The user device 102 is arranged to store user action data 122 indicating user actions performed at the user device 102 while an instance of the three-dimensional environment is rendered via the user device 102. The user actions may include actions performed using the input devices 114 to adjust the position, orientation, or field of view of the virtual camera, thereby to adjust which portion of the environment is visible to the user. Alternatively, or additionally, the user actions or to select or otherwise interact with assets within the three-dimensional environment. The user action data may indicate respective locations in the three-dimensional environment associated with the performing of at least some of the user actions. The indicated locations for a given user action may correspond to a focal position on an object such as a three-dimensional model within the environment, relating to a position and/or orientation of the virtual camera relative to the object before or after the user action is performed. User action data for certain user actions may indicate a specific digital asset within the three-dimensional environment, for example if the user action involves the user selecting a specific digital asset. Examples of user actions will be described in detail hereinafter. According to the present disclosure, the user action data 122 is collected and transmitted (synchronously or asynchronously) to the data processing system 100.

The data processing system 100 may be a standalone server or a networked system of servers, for example a distributed server system providing cloud-based services. The data processing system 100 may be operated by a commercial entity responsible for managing the distribution of digital content to end users. The commercial entity may for example be an online retailer or a service provider managing distribution of digital content on behalf of one or more private or commercial clients. Accordingly, the data processing system 100 may expose one or more application programming interfaces (APIs) 138 for communicating with one or more client systems. In some examples, a user or client of the data processing system 100 may design a three-dimensional environment and/or populate a three-dimensional environment with digital assets. The process of arranging the digital assets may be performed manually using an appropriate software tool or with a degree of automation, as will be explained in more detail hereinafter. When the user or client has finished populating the three-dimensional environment with digital assets, the three-dimensional environment can be “published”, enabling end users to download and interact instances of the three-dimensional environment.

The data processing system 100 includes memory 126, which encompasses both volatile and non-volatile memory and storage devices. The memory 126 is arranged to store user action data 128 received from the user device 102 and potentially many other user devices. The user action data 128 indicates user actions performed at the user devices while respective instances of the three-dimensional environment are rendered via the user devices. The user action data 128 may be received and stored in a raw, unprocessed format, in which case the user action data 128 may be referred to as raw user action data. The raw user action data may for example be stored in the form of individual user action events each corresponding to an individual user action performed at a user device. An individual user action event may be stored in the form of a data structure including multiple fields, such as the type of user action, an associated location (or locations) within the three-dimensional environment, a time at which the user action was performed, a device identifier, a session identifier, an environment identifier indicating in which three-dimensional environment the user action was performed, a version identifier indicating a version of the three-dimensional environment, and various other metadata fields for example associated with the user and/or the user device at which the user action was performed. In this way, the user action data 128 may efficiently store all necessary information to reconstruct a user's session interacting with an instance of the three-dimensional environment, whilst also being in a suitable form for aggregation and further processing, as explained in more detail hereinafter.

The raw user action data may be stored in a set of in access log files (such as CloudFront™ access logs) in a cloud-based Simple Storage Service™ (S3) bucket hosted by Amazon Web Services™ (AWS), or within Blob storage by Microsoft Azure™, or an equivalent unstructured data store. In the AWS implementation, each access log file may include user action events received from user devices within a fixed time period (for example within a given hour). The raw user action data may be stored in encrypted or unencrypted form, depending on the sensitivity of the indicated user actions.

The data processing system 100 includes a data preparation engine 129 which has the task of preparing the user action data 128 for processing by machine learning algorithms or other algorithms for determining a spatial configuration or order for a set of digital assets. In an example where user action data is stored in access log files in an S3 bucket, the data preparation engine 129 may be implemented using jobs defined within AWS Glue™. These jobs may be scheduled and chained using AWS Step Functions™. An exemplary three-stage data preparation pipeline includes a validation job, followed by an enrichment job, followed by an aggregation job. The validation job checks user action events against a defined schema to ensure that all required data is present and in the correct format. The enrichment job may append additional information to user action events, for example metadata not directly provided by the user device, for example user and/or session identifiers. Aggregation jobs may be used to aggregate user action events into data suitable for processing algorithms. The user action events may be aggregated separately for different combinations of variables, including for selected time periods, device types, user identifiers, and so on. In some examples, an aggregation job may be used to determine a spatial distribution of user focus within the three-dimensional environment, as explained in more detail hereinafter. The aggregation job is typically performed automatically and by the data preparation engine 129, asynchronously from the receiving of the user action data 128.

In addition to the user action data 128, the memory 126 of the data processing system 100 stores 3D environment data 130 representing the three-dimensional environment rendered at the user devices, and digital asset data 132 relating to the digital assets appearing within the three-dimensional environment. The 3D environment data 130 stored at the data processing system 100 may correspond substantially to the 3D environment data 120 stored at the user device 102, for example encoding the geometry and surface appearance of three-dimensional models along with locations of digital assets located within the three-dimensional environment. Alternatively, the 3D environment data 130 may include only information necessary for processing operations by the data processing system 100, for example indicating a scale, position and/or orientation of each digital asset within the three-dimensional environment. By maintaining such information, the data processing system 100 may be able to correlate user actions performed at the user devices with digital assets within the three-dimensional environment, as described in more detail hereinafter.

The digital asset data 132 may include image data, video data, text data, audio data, three-dimensional model data, or a combination of any of these, and/or any other type of media that can be presented within the digital environment. The digital asset data 132 may further include meta-data representing characteristics or attributes associated with the data files. In an example where a digital asset corresponds to a physical product, the digital assets data 132 may include an image or video of the product, along with information such as price, description, producer, taxonomy, and so on. In addition to the digital asset data 132, the memory 126 further stores relationship data 134 indicating relationships between digital assets, or groups of digital assets. The relationship data 134 may further indicate relationships between digital assets and cohorts of users, for example users, user devices, or sessions having particular sets of attributes. Cohorts of users may be user-defined, or may be identified based on attributes or based on behavioural similarities when interacting with 3D environments.

The relationship data 134 may for example indicate that certain digital assets are members of a group or cluster. Such groupings may be hierarchical. For example, a digital asset representing a certain model of training shoe may be grouped with other training shoes of the same brand. The training shoe group may then be a member of a higher-level group representing clothes of the same brand. The relationships may initially be defined manually by a user or client of the data processing system 100. As will be explained in more detail hereinafter, the methods described herein may result in the relationships between digital assets being updated based on the actions of users interacting with the three-dimensional environment.

The digital asset data 132 and the relationship data 134 may be stored by means of a graph database in which the digital asset data 132 is stored within nodes and the relationship data 134 is stored within edges. A given node may be associated with a specific asset or group of assets. Other nodes may be associated with user cohorts, enabling the graph database to store associations between digital assets or groups of digital assets and particular cohorts of users. The edges of the graph database may store directed or undirected links between at least some of the digital assets, groups of digital assets, or user cohorts. For example, an undirected link may indicate an association between two digital assets, or between a cohort of users and a group of digital assets. A directed link may indicate an ordered association between digital assets or groups of digital assets. For example, an asset representing a film within a series of films may be followed by a subsequent film in the same series, and this information may be represented by a directed edge. The edges may be configured to have associated probability values or other scores indicating a strength or priority of connections between nodes, as will be explained in more detail hereinafter. It will be appreciated that a graph database is well-suited to storing information pertaining to relationships between digital assets and/or cohorts of users, and enables such information to be queried more efficiently than would be the case for other types of database, such as relational databases. Nevertheless, in other examples the digital asset data 132 and/or relationship data 134 may alternatively, or additionally, be stored in a relational database or any other suitable data structure, such as by means of a fact and dimension table.

The data processing system 100 includes an inference engine 136 coupled to the memory 126 and configured to process the user action data 128, the 3D environment data 130, the digital asset data 132, and/or the relationship data 134, to select digital assets for rendering via one or more user devices. The inference engine 136 may be implemented by software executed by one or more processors, such as central processing units (CPUs), graphics processing units (GPUs), neural processing units (NPUs), or any other type of suitable processing circuitry, and may further include memory circuitry. The inference engine 136 may for example be arranged to generate a new three-dimensional environment, or a new version of an existing three-dimensional environment, in which the selected digital assets are positioned. In this case, the inference engine 136 may further be arranged to determine a spatial configuration for the selected digital assets. Alternatively, or additionally, the inference engine 136 may be arranged to determine a path through an existing or new three-dimensional environment, such that when a virtual camera moves along the determined path, the selected digital assets are presented to a user in a sequential fashion. Examples of methods carried out by the inference engine 136 will be discussed in detail hereinafter.

The inference engine 136 may be arranged to select digital assets automatically, without user input. Alternatively, the inference engine 136 may select digital assets in response to a request from a user or client of the data processing system 100. The user or client may for example be provided with a software tool for designing a three-dimensional environment. The software tool may be provided either as a locally-executed software product or via a software-as-a-service model. The software tool may enable the user or client to select and arrange digital assets for presentation within a three-dimensional environment, either directly within the three-dimensional environment or in a two-dimensional plane which is later mapped to a model within the three-dimensional environment. The software tool may also enable the user or client to define paths or journeys through the three-dimensional environment, and/or between digital assets. Using the methods set out in the present disclosure, the software tool may be provided with functionality to assist the user or client in selecting the digital assets or determining paths between the digital assets, either automatically or by providing a recommendation or suggestion to the user of the software tool.

The selecting of digital assets may alternatively be performed in response to a request or other user action at an end user device via which the digital assets are to be rendered. In this way, a three-dimensional environment and/or journey may be dynamically generated such that the resulting user experience is personalised to the user of the end user device and may take into account real time context information.

The inference engine 136 may be arranged to determine a spatial arrangement for a set of digital assets, for use in rendering the set of digital assets. For example, the inference engine 136 may generate a new three-dimensional environment, or a new version of an existing three-dimensional environment, in which the digital assets are positioned in accordance with the determined spatial configuration. The inference engine 136 may determine which digital assets are to be presented on a three-dimensional model and allocate respective positions on the three-dimensional model to those digital assets. The data processing system 100 may then transmit data indicative of the three-dimensional model to one or more user devices for rendering. Alternatively, data indicative of the set of digital assets and/or spatial configuration may be transmitted to one or more user devices and the mapping of digital assets to three-dimensional models may be performed at the user devices.

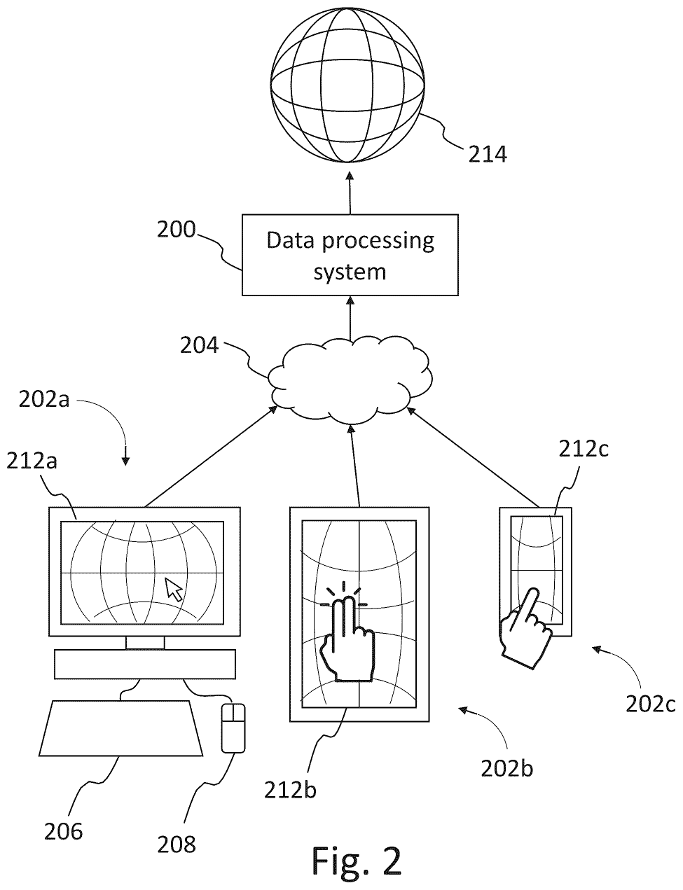

FIG. 2 shows a data processing system 200 (which may include similar functional components to the data processing system 100 of FIG. 1) connected via a network 204 to a large number of user devices, referred to collectively as user devices 202, of which three user devices 202a, 202b and 202c are shown. Data representing respective instances of a three-dimensional environment is transmitted to the user devices 202. The three-dimensional environment in this example includes a three-dimensional model upon which digital assets are positioned. The three-dimensional model is substantially sphere-shaped (e.g. spherical, spheroid, or formed of spherical or similarly-shaped portions with rotational symmetry about at least one axis), and the objects are mapped to a concave interior surface of the model.

Each of the user devices 202 includes a respective display device 212a, 212b, 212c via which the three-dimensional environment is presented from a perspective of a virtual camera. Each instance of the virtual camera in this example has a field of view containing a portion of a concave interior surface of the three-dimensional model. The virtual camera may for example be located within the interior of the three-dimensional model and/or may be located outside the three-dimensional model but configured to “see through” a nearest surface of the three-dimensional model, for example by excluding certain portions of the model from rendering based on directions of their outward-facing normal vectors.

In this example, each of the user devices 202 is provided with a separate instance of the three-dimensional environment and there is no direct interaction between users of the user devices 202. Different portions of the three-dimensional model may be displayed on different user devices 202, depending on the positions and orientations of their respective instances of the virtual camera, and further depending on the viewport dimensions of the user devices 202. A viewport is a display or a portion of a display in which information is presented and can be viewed. In the present example, the viewport of each of the user devices 202 includes substantially the entire display of that user device 202, though in other examples a viewport may cover only a portion of a display, for example a browsing window on a webpage or graphical operating system. The viewport dimensions may vary between the user devices 202. For example, the user device 202a is a desktop computer, and therefore has a landscape aspect ratio and relatively large display area. The user device 202b is a tablet computer being used in portrait orientation, and has a smaller display area than that of the desktop computer. The user device 202c is a smartphone being used in portrait orientation, and has a smaller display area than that of the tablet computer. Due to the differing viewport dimensions, different portions of the three-dimensional model are rendered on the different user devices 202 for a given position and orientation of the virtual camera (the interior surface of the three-dimensional model is represented in FIG. 2 using curved gridlines).

Each of the user devices 202a, 202b, 202c has one or more input devices arranged to receive user actions for controlling the virtual camera on that user device. In this example, the user device 202a has a keyboard 206 and mouse 208 for controlling an on-screen cursor, whereas the display devices 212b, 212c of the user devices 202b, 202c are touch screens arranged to receive user input by human touch and accordingly do not make use of an on-screen cursor. Other examples of input devices include joysticks, trackpads, sliders, gesture detectors and eye trackers (which may include one or more cameras and object detection software). Examples of user actions include move actions, in which the position and/or orientation of the virtual camera is adjusted in relation to the three-dimensional model (or vice-versa). A specific type of move action is a rotational move action in which the virtual camera rotates around an axis (or the three-dimensional model rotates around the virtual camera). The axis may pass through the virtual camera, in which case the rotate action adjusts only the orientation of the virtual camera, or the axis may be set away from the virtual camera, in which case the rotate action adjusts both the position and orientation of the virtual camera. A rotate action may be performed for example by a user pressing a directional arrow on a keyboard, or by dragging a point on the surface of the model in the appropriate direction, either by holding down a button on a mouse or by sliding a finger across a touch screen. In other examples, other types of move actions may be possible, for example a translate action in which a virtual camera moves in a given direction without any rotation.

Data indicative of user actions may be transmitted from the user devices 202 to the data processing system 200. The data processing system 200 is configured to use the user action data to select digital assets for rendering via one or more user devices 202, which may include one or more of the user devices 202 from which the user action data is received or may be an entirely different set of user devices 202. The selecting of digital assets may be performed automatically, or in response to input from a user of the data processing system 200, or in response to input from a user of one of the user devices 202. In this example, the data processing system 200 is arranged to select a set of digital assets and generate a three-dimensional model 214 upon which the selected set of digital assets are positioned. The generated three-dimensional model 214 in this example has an identical geometry to the three-dimensional model originally rendered by the user devices 202, but includes a different set of digital assets. The data processing system 200 may also be arranged to determine a spatial configuration for the digital assets, thereby fully automating the process of generating the three-dimensional environment. The spatial configuration may be determined in dependence on the user action data. Alternatively, or additionally, the spatial configuration may be determined using a suitable sorting algorithm and/or packing algorithm. Suitable packing algorithms for this purpose are discussed in International Application No. PCT/EP2011/059022, published as WO 2011/151367, the entirety of which is incorporated herein by reference.

In accordance with certain examples, methods of selecting digital assets may include determining a spatial distribution of user focus within a three-dimensional environment. For example, the data preparation engine 129 and/or the inference engine 136 of FIG. 1 may be arranged to analyse the user action data 128 to identify regions of the three-dimensional environment corresponding to high levels of user focus. The inference engine 136 may then use the 3D environment data 138 to correlate the identified regions with particular digital assets, or groups of digital assets, in order to determine which digital assets or groups of digital assets received high levels of interest or attention from users. The inference engine 136 may for example select digital assets associated with high levels of interest or attention for subsequent rendering.

Methods of determining a distribution of user focus within a three-dimensional environment are discussed in detail in International Application No. PCT/GB2022/052747, the entirety of which is incorporated herein by reference. In particular, methods may include tracking user actions which control the position of a virtual camera within the three-dimensional environment. Examples of such user actions are described below in the context of a three-dimensional environment containing a substantially spherical model.

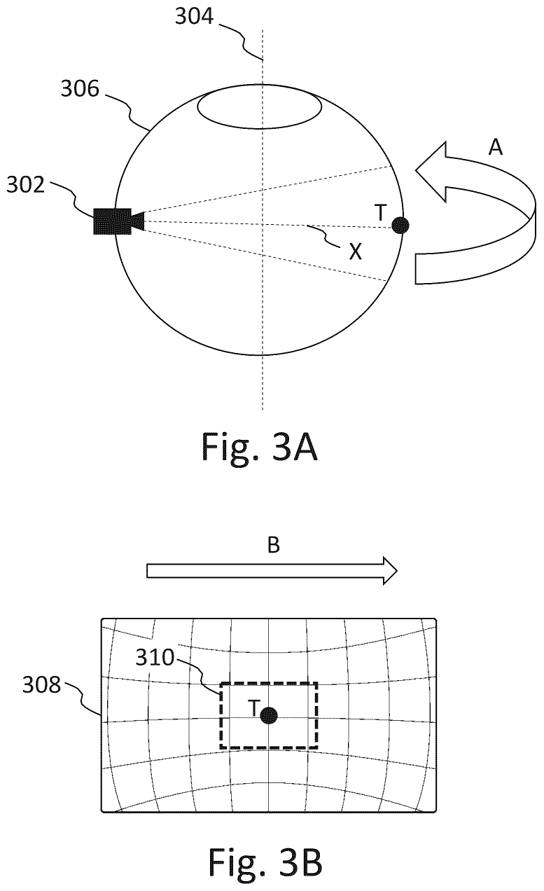

FIG. 3A shows an example of a rotate action in which a virtual camera 302 arranged to view a concave interior surface of a spherical model 304 is rotated in a direction shown by the arrow A, about an axis 306 passing through the centre of the model 304, where the axis 306 is fixed relative to the model 304 (or, equivalently, the three-dimensional model 304 is rotated about the axis 306, which is fixed relative to the virtual camera 302). FIG. 3B illustrates the effect of the rotate action of FIG. 3A in the viewport 308 of a user device when the model 306 is rendered from the perspective of the virtual camera 302. The concave interior surface (represented by curved gridlines), and objects disposed thereon (not shown) move substantially in the direction of the arrow B.

A second type of user action is a zoom action, in which an angle subtended by the field of view of the virtual camera is adjusted and/or the distance of the virtual camera from a three-dimensional model is adjusted in order to increase or decrease the proportion of the viewport occupied by a given portion of the three-dimensional model. A zoom action towards or away from a given point on the model may be performed for example by a user pressing a button on a keyboard or scrolling a scroll wheel on a mouse whilst the cursor at the given point, or performing a pinch action at the given point using two fingers on a touch screen. A zoom action may be characterised by a zoom factor, where a zoom factor of greater than one indicates zooming towards a given point, whereas a zoom factor of between zero and one indicates zooming away from a given point.

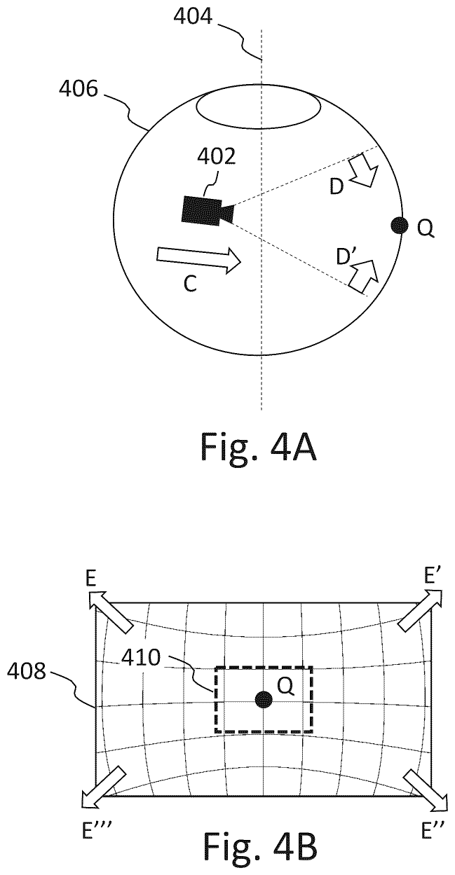

FIG. 4A shows an example of a zoom action in which the virtual camera 402 arranged to view a convex interior surface of a spherical model 404 moves relative to the model 404 in a direction substantially towards a point P on the surface in a direction shown by the arrow C, and narrows its field of view as indicated by the arrows D and D′. FIG. 4B illustrates the effect of the zoom action of FIG. 4A in the viewport 408 of a user device when the model 406 is rendered from the perspective of the virtual camera 402. The surface of the model 404 appears to expand as shown by the arrows E, E′, E″, E′″. In other examples, a zoom action may omit either the movement of the virtual camera or the adjusting of the angle subtended by the field of view, and/or may further include a rotation of the virtual camera. Different zooming algorithms are possible depending on the context. In some examples, if the user zooms far enough towards a given objective point, the surface at the objective point appears at normal incidence at the centre of the field of view of the virtual camera. In this situation, a region of the model immediately surrounding the objective location appears head-on, allowing the user to view the neighbourhood of the objective location with maximum clarity. In order to achieve this, upon receiving the request to perform a zoom action, the virtual camera may move along a path depending on the determined objective point until the virtual camera is positioned on a normal to the model at the determined objective point. The virtual camera is then reoriented to face towards the determined objective location, and the dimension of the field of view of the virtual camera may be decreased so that a smaller portion of the model falls within the field of view of the virtual camera. If further zooming is requested, the virtual camera remains on the normal and the dimension of the field of view is adjusted in accordance with the requested zoom factor.

A user action received by a user device may have an associated focal position. The focal position may be a point or region on a surface of the three-dimensional model that the user brings, or intends to bring, into a position of maximum viewability by performing the user action. In the case of a three-dimensional model having a curved surface, a position of maximum viewability may for be one at which a normal vector to the surface faces substantially towards the virtual camera, or one for which an angle between the normal vector and the axis of the virtual camera is minimum. At this point, the surface is perpendicular, or nearly perpendicular, to the axis of the virtual camera, and is therefore viewed in a head-on fashion from the perspective of the camera. It will be appreciated that the concept of a point or region of maximum viewability has extra significance for three-dimensional models, where different portions of the model can have different degrees of viewability, even when lying within the same viewport. In other examples (for example when a range of points have equal viewability), a focal position may be a point appearing centrally within the viewport or closest to the centre of the viewport. The focal position for a given user action may be dependent on, and indeed derivable from, the position and/or orientation of the virtual camera relative to the three-dimensional model following the user action, and may also be (implicitly or explicitly) dependent on the geometry of the surface.

In the case of a move action (such as a rotate action), the focal position may be a target of the virtual camera, or in other words an intersection between a surface of the three-dimensional model and an axis of the virtual camera. In the rotate action of FIGS. 3A and 3B, the target T of the virtual camera 302 is an intersection between the axis X of the virtual camera 302 and an interior surface of the model 306. It is observed that a dashed region 310 surrounding the target T appears approximately flat and head-on from the perspective of the virtual camera 302. The user focus following the rotate action may be considered to be concentrated within this region. The position and dimensions of the region 310 depend on the target T, the dimensions of the viewport 308, and the geometry of the model 306. Accordingly, the information pertinent to determining user focus following the rotate action may include the target T and the dimensions of the viewport 308, along with the geometry of the model 306.

In the case of a zoom action, the focal position may be determined as an objective point specified by the user during a request to zoom, or alternatively may be depend on the final position and orientation of the virtual camera following the zoom action. The zoom action of FIGS. 4A and 4B ends with the point P lying at the centre of the viewport, with the surface of the model 406 perpendicular to the axis of the camera at this point. The point P may therefore be considered the focal position following the zoom action. The dashed region 410 surrounding the point Q appears approximately flat and head-on from the perspective of the virtual camera 402. The user focus following the zoom action may be considered to be concentrated within this region. The position and dimensions of the region 410 depend on the point Q, the dimensions of the viewport 408, and the geometry of the model 406.

A method of determining a spatial distribution of user focus on a three-dimensional model may involve dividing the surface of a three-dimensional model (or on a two-dimensional plane mapped to the surface of the model) into grid squares at a given resolution, and a value determined for each grid square indicating of a level of user focus on that grid square over a given period of time. The grid squares may initially be assigned a value (such as zero) corresponding to zero user focus, and each user action indicated within the given period of time may increase the user focus on certain grid squares. For example, a maximum value may be added to the grid square containing the focal position of the user action, then a lower value added to grid squares immediately neighbouring the focal position, then lower values to grid squares further away from the focal position, dropping to zero for grid squares far from the focal position, including at least those not falling within the viewport following the user action. The contribution of a given user action to the spatial distribution of user focus may be characterised by a filter or kernel, which is a matrix of numerical values indicating the contribution of the user action to the user focus on each grid square.

The contribution to the spatial distribution of user focus, for example the values and domain of influence of a filter or kernel, may depend on the viewport dimensions of the user device, the zoom level following the user action, and/or the type of user action. For the user actions of FIGS. 3B and 4B, the contribution to the grid squares inside the regions 310 and 410 may be higher than the contribution to the grid squares outside the regions 310 and 410. The shapes and sizes of these regions depend on the viewport dimensions (e.g. the aspect ratio) and the respective zoom levels. The contribution to the grid squares inside these regions may be uniform, or may vary such as by decreasing away from the centre of the regions.

The contribution to the spatial distribution of user focus may further depend on the time between a given user event and the next user event performed on the same user device. The time between successive user events may correspond to the time period for which the model appears stationary within the viewport. The focus level of an individual user may be considered to increase with this time period, for example proportionally up to a predetermined saturation time (for example 10 seconds, 20 seconds, a minute, or any other suitable period of time depending on the specific use case), during which it is assumed that the user is continuing to view the model. After the saturation time, it is no longer assumed that the user is still viewing the model and therefore the focus level stops increasing.

Although determining the spatial distribution of user focus has been described above with reference to the application of a kernel to a matrix of values corresponding to grid squares on a surface of the model, it will be appreciated that other methods of determining a spatial distribution are possible. For example, a set of points may be distributed around the focal position for a given user action, for example with a maximum density immediately surrounding the focal position and decreasing away from the focal position. The locations of the points may then be used to determine parameters of a continuous spatial distribution for the points assuming the points are generated according to a random spatially varying process such a Poisson process. Other methods of generating heatmaps from distributions of points, such as simple histogram-based methods, are known in the art and could equally be used here.

The spatial distribution of user focus may correspond to user actions performed within a particular time period, for example within a particular hour. A series of spatial distributions may be determined, each corresponding to a different time period, from which temporal variations in user focus may be identified. These temporal variations may be correlated with events, such as times of day, days of the week, public holidays, and so on. Furthermore, several spatial distributions may be determined over respective different periods of time (for example, a separate distribution for each hour), and these may be aggregated (e.g. summed or averaged) over the respective different periods of time to generate time-aggregated spatial distributions. For example, spatial distributions corresponding to 24 hours may be aggregated to generate a spatial distribution of user focus in a day. This may be performed for each day (e.g. starting at 00:00 and ending at 23:59.59), or may be performed as a moving average. Efficient methods of computing moving averages are well-known and may be used here. Similarly, spatial distributions corresponding to a given number days may be aggregated to generate a spatial distribution of user focus in a week, month, or year. Nested aggregation may be performed to allow variations to be identified at various levels of temporal granularity. User focus may also be aggregated for particular values of one or more context variables.

Returning to FIG. 1, the inference engine 136 may be arranged to select digital assets in dependence on context data. For example, the inference engine 136 may determine that attention levels for certain digital assets or groups of digital assets are high for cohorts of users, sessions or devices, and accordingly select such digital assets for subsequent rendering by users, sessions or devices in the same cohort. User focus may for example be aggregated for a cohort having particular values of a set of context variables. Examples of context variables include device type, geographical location, age of user, date of session, time of day, and so on. Attention scores may be allocated to digital assets in dependence on the corresponding distribution of user focus for the cohort, and these attention scores may be used to select digital assets for rendering by another user, session, or device in the same cohort. The inference engine 136 may be arranged to select digital assets for rendering users or devices in a given cohort based on the allocated attention scores for that cohort. The inference engine 136 may for example select the digital assets or groups of digital assets for which the highest attention scores have been allocated for the cohort.

The inference engine 136 may be arranged to determine an association or connection between digital assets or groups of digital assets for use in selecting a set of digital assets for subsequent rendering. In examples where the digital asset data 132 and the relationship data 134 are stored in a graph database, the inference engine 136 may be configured to store data within the edges of the graph database. For example, the inference engine 136 may determine that users who view or interact with a first digital asset frequently also view or interact with a second digital asset. The inference engine 136 may accordingly increase a value associated with an edge between nodes representing the first digital asset and the second digital asset, or create an edge if no edge previously existed. The inference engine 136 may similarly update edges between groups or clusters of digital assets, or between user cohorts and digital assets or groups of digital assets. For example, where the inference engine 136 is used to allocate or predict cohort-specific attention scores for digital assets as discussed above, data indicative of the cohort-specific attention scores may be stored in corresponding edges of the graph database.

By performing a similar procedure for a large number of users, the relationship data 134 may represent empirically-deduced relationships between assets, groups of assets, and cohorts of users, which may be used in selecting digital assets for subsequent rendering. The inference engine 136 may further use the relationships between digital assets to determine a spatial configuration for the selected set of digital assets. For example, the inference engine may position groups of assets which are strongly linked adjacent to one another.

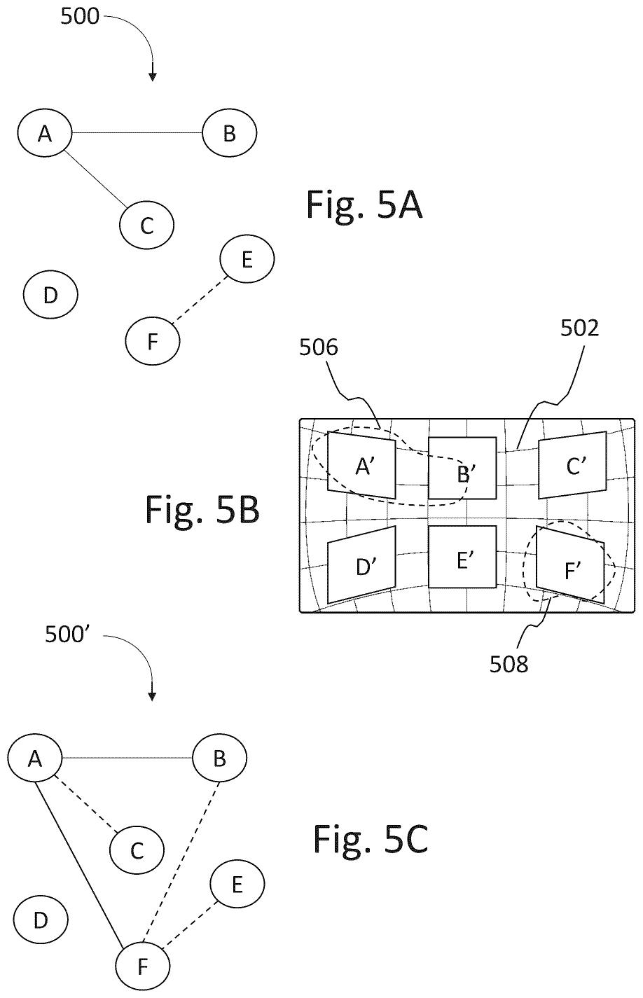

An association or relationship between digital assets or groups of digital assets may be determined based on user focus levels. The inference engine 136 may for example process the user action data 128 to determine levels of user focus within the three-dimensional environment and then use the 3D environment data 130 to correlate regions of high user focus with particular assets or groups of assets appearing within those regions. FIG. 5A shows an example of a graph 500 including nodes labelled A, B, C, D, E, F. The nodes A, B, C, D, E, F may respectively represent digital assets A′, B′, C′, D′, E′, F positioned on a three-dimensional model 502 in a three-dimensional environment, as shown in FIG. 5B. In other examples, one or more of the nodes A, B, C, D, E, F may represent a group of digital assets. The graph 500 includes edges between nodes A and B, between nodes A and C, and between nodes E and F, representing associations between the corresponding pairs of digital assets A′ and B′, A′ and C′, E′ and F′. The edges are allocated scores representing a significance or strength of the association. The association between nodes A and B, and the association between nodes A and C, are relatively strong, in which case the edge is represented as a solid line. The association between nodes E and F is relatively weak, in which case the edge is represented as a dashed line.

In the example of FIG. 5B, a spatial distribution of user focus has been determined based on user action data from users interacting with the three-dimensional model 502. Two regions 506 and 508, enclosed by dashed curves, are determined to have high user focus values (e.g. higher than a given threshold). From this, it may be determined that there is an association between the digital assets A′, B′ and F′. Accordingly, the graph 500 may be updated to indicate stronger associations between nodes A, B and F, as indicated by the updated edges shown in the graph 500′. As a result of this user data, the strengths of other edges may be decreased, as shown for the edge between nodes A and C.

In other examples, user focus and/or 3D environment data 130 may not be needed to determine an association between digital assets or groups of digital assets, for example if the user action data directly indicates interactions with the digital assets. This may occur in the case of a user action in which a user explicitly selects digital assets, for example by “clicking” or “tapping” on the digital asset, depending on the type of input device.

In examples where the digital asset data 132 and the relationship data 134 are stored in a graph database, the inference engine 136 may be configured to update the edges within the graph database. For example, the inference engine 136 may determine that users who view or interact with a first asset frequently also view or interact with a second asset. The inference engine 136 may accordingly increase a value associated with a corresponding directed or undirected edge between the first asset and the second asset, or create a directed or undirected edge between the first asset and the second asset if no edge previously existed. The inference engine 136 may similarly determine a connection between groups or clusters of assets and similarly update edges between groups of clusters. By performing a similar procedure for a large number of users, the relationship data 134 may represent empirically-deduced relationships between assets or groups of assets, which may be used in determining a new spatial configuration or order for the digital assets. For example, the inference engine may position groups of assets which are strongly linked adjacent to one another, or may order groups of assets in dependence on the strength of the connections, such that a path through a three-dimensional environment may be determined in which the assets are presented in the determined order.

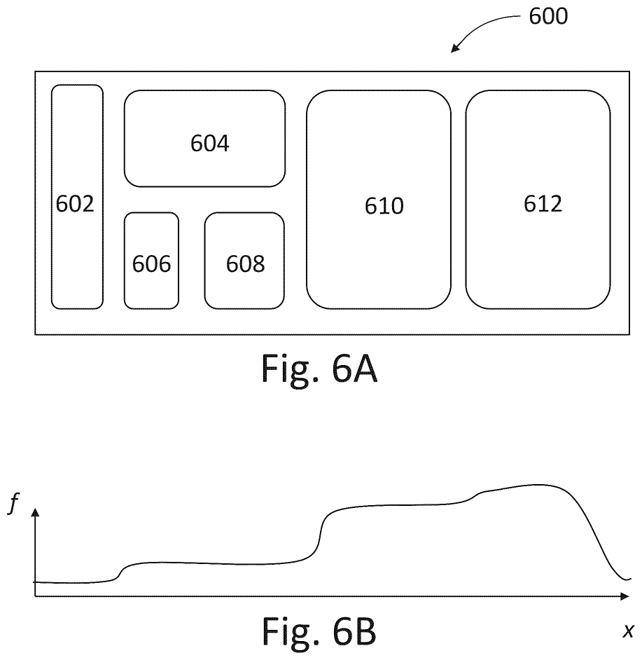

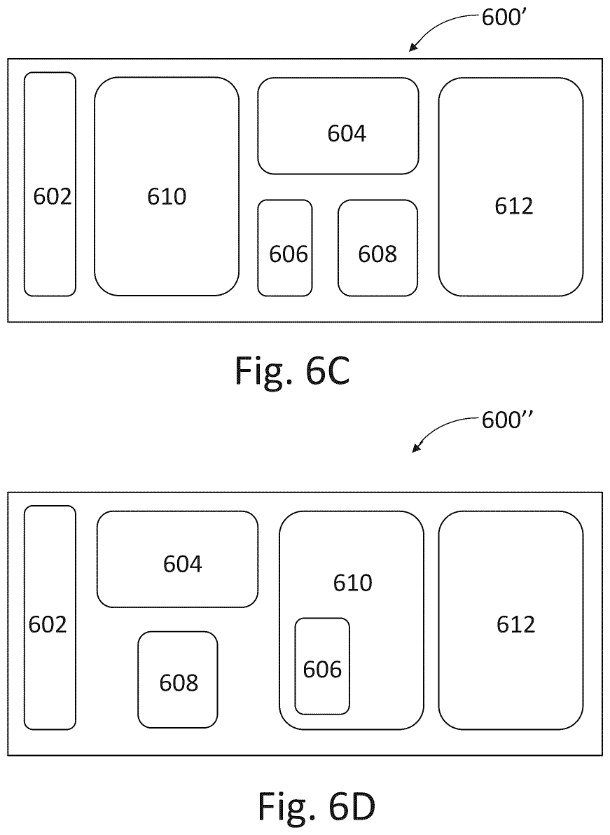

FIGS. 6A-D show examples in which a spatial configuration for a set of digital assets is determined using based on a spatial distribution of user focus on a three-dimensional model. FIG. 6A shows an example of a two-dimensional planogram 600 for mapping to a surface of a three-dimensional model within a three-dimensional model. In this example, the planogram is mapped to an interior surface of a substantially sphere-shaped model using a two-square mapping. The planogram 600 includes several digital assets arranged in clusters 602, 604, 606, 608, 610, 612. When mapped to the sphere-shaped model, the planogram wraps around a vertical axis to enable continuous scrolling with clusters 602 and 612 appearing next to one another. The planogram 600 may be represented at several levels of detail (not shown) such that different information is visible when the three-dimensional model is viewed at different zoom levels.

FIG. 6B is a graph showing the variation of user focus f with position x along the horizontal axis of the planogram 600 for a large number of users (where the user focus f is summed over the vertical position), determined using the methods described herein. It is observed that the user focus f is highest around the cluster 612, slightly lower around cluster 610, still lower around clusters 604, 606, 608, and lowest around cluster 602. In this example, it is observed that the clusters which receive most attention from users are next to one another and therefore concentrated on one side of the three-dimensional model. In the context of an online retail environment, in which the clusters of objects correspond to different categories of objects or objects sharing a common characteristic, it may be undesirable for the clusters to be arranged in this way. Having the most popular items located on one region of the model may result in fewer users viewing items on other parts of the model, particularly if the less popular digital assets are more profitable or if there is a specific reason for wanting users to view more of the less popular assets, such as due to suppliers associated with the less popular assets paying a premium rate for advertising their products.

In order to mitigate the undesirable effects described above, it may be advantageous to generate a new planogram in which the clusters which receive the most user focus are evenly spaced around the three-dimensional model. FIG. 6C shows such a planogram 600′, in which the clusters 610 and 612, which previously received the most user focus, have been relocated to positions which are mapped to opposite sides of the three-dimensional model. Such an arrangement may increase the levels of user focus on the clusters 602, 604, 606, 608. Although in this example objects are rearranged in clusters, in other examples objects may be rearranged on an individual basis.

The rearranging of digital assets may be performed using a rules-based algorithm or a machine learning algorithm, resulting in a modified spatial configuration of digital assets for mapping to the three-dimensional model. The machine learning algorithm may be trained to maximise an objective function or reward function, which may depend on one or more metrics such as average user session duration, number of revisits, or earnings from sale of products corresponding to assets displayed on the three-dimensional model. In some examples, the objective function may be arranged to maximise views or clicks on particular assets or groups of assets (e.g. those manually designated by a human user, or those for which measured numbers of views or interactions are low). In any case, the algorithm may be given the task of increasing views or clicks on assets corresponding to the cluster 606 in FIG. 6A. As a result, algorithm may rearrange the spatial configuration of assets to that of the planogram 600′ of FIG. 6C. Since the cluster 606 appears between the clusters 610 and 612, which previously received the highest levels of user focus, this new configuration may increase the level of user focus on the cluster 606. Alternatively, the algorithm may rearrange the spatial configuration of assets to that of the planogram 600″ of FIG. 6D, in which the cluster 606 has been subsumed into the cluster 610, which may similarly increase the level of user focus on the cluster 606.

As demonstrated by FIGS. 6C and 6D, there may be more than one way in which a spatial configuration for a set of digital assets may be improved according to some metric. In some cases, the inference engine 136 may automatically select a spatial configuration, for example based on a level of user focus or a value of another metric as predicted by a machine learning model. Alternatively, the inference engine 136 may present multiple options from which a human designer can select. As a further alternative, multiple 3D environments may be generated and rendered at respective different sets of user devices, and further evaluated against a given metric. The spatial configuration achieving the highest value of the given metric may then be provided to further user devices. This process effectively enables A/B testing of 3D environments to be carried automatically. The process may be performed over multiple iterations, enabling the 3D environments may evolve in dependence on observed user behaviour.

In cases where the inference engine 136 is arranged to determine an ordering for a set of digital assets, the inference engine 136 may be arranged determine a path through a three-dimensional environment containing the digital assets. The data processing system 100 may then transmit data to one or more user devices indicating the determined path such that the user devices may render the three-dimensional environment from a perspective which moves automatically relative to the three-dimensional environment so as to present the plurality of digital assets in the determined order. Alternatively, the data processing system 100 may transmit data indicative of the determined ordering to one or more user devices, and the user devices may determine a path through a three-dimensional environment locally. Different user devices may render different environments, or different versions of environments, in which case different paths may be determined for a given order of the digital assets.

In examples where the digital asset data 132 and the relationship data 134 are stored in a graph database, the inference engine 136 may be configured to update the edges within the graph database. For example, the inference engine 136 may determine that users who view or interact with a first asset frequently also view or interact with at a second asset. The inference engine 136 may accordingly increase a value associated with a corresponding directed or undirected edge between the first asset and the second asset, or create a directed or undirected edge between the first asset and the second asset if no edge previously existed. The inference engine 136 may similarly determine a connection between groups or clusters of assets and similarly update edges between groups of clusters. By performing a similar procedure for a large number of users, the relationship data 134 may represent empirically-deduced relationships between assets or groups of assets, which may be used in determining a new spatial configuration or order for the digital assets. For example, the inference engine may position groups of assets which are strongly linked adjacent to one another, or may order groups of assets in dependence on the strength of the connections, such that a path through a three-dimensional environment may be determined in which the assets are presented in the determined order.

The inference engine 136 may use a machine learning model such as a graph neural network to select a set of digital assets and/or to determine a spatial arrangement or order for a set of digital assets. For example, the inference engine 136 may process a series of user actions performed during a single session, or by a given user over several sessions, to reconstruct a path between digital assets or groups of digital assets, for example by correlating locations in the digital environment with digital assets as described above. The path between digital assets may be represented as a graph with nodes encoding characteristics of the digital assets or groups of digital assets and the edges corresponding to portions of the path between the digital assets or groups of digital assets. The corresponding session may be scored according to a given metric. In an example of an online retail environment, the score for a session may correspond to a value of purchases made during the session. Alternatively, or additionally, the metric may depend on a number of times the user returns to the three-dimensional environment, the duration of the session, or any other metric which directly or indirectly measures a figure of merit relevant to a user or client of the data processing system 100, such as user engagement or financial value.

The graph neural network may be trained to receive an input graph indicating a path between digital assets, optionally with context information for the session, such as information relating to the device and/or user. Supervised learning may then be used to train the graph neural network to predict the score for a given path between assets or groups of assets. By performing this training over a large number of sessions, the graph neural network may learn which paths typically lead to a high scoring session, either generally or for specific context information. The graph neural network may then be used to predict a metric score (and, optionally, uncertainty in the predicted metric score) for a candidate path. The candidate path may be determined by any suitable method, for example using sampling or Bayesian optimisation, enabling the space of paths to be tested efficiently. Instead of taking an individual session or series of sessions as a training example, a graph neural network or other machine learning model may be configured to process user action data aggregated over multiple unconnected sessions, in which case the metric used for training may also be an aggregated metric.

Using the trained graph neural network model, the inference engine 136 may determine a path between digital assets or groups of digital assets for which a high metric score is predicted, and determine a spatial configuration or order for the digital assets based on this path. The determined path may be made dependent on context information, enabling the resulting spatial configuration or order to be tailored to a specific session, user or device. In an example where the inference engine 136 dynamically determines the spatial configuration or order in response to a user action at one of the end user devices, live context information may be used.

In some examples, users may be presented with instances of different three-dimensional environments (which may have been generated manually or using the methods described herein). A graph structure may be used to encode the layout of digital assets in the different environments, for example by providing edges with values depending on the proximity or displacement vectors between assets or groups of assets, or any other suitable encoding for example capturing the order or spatial configuration. The different layouts may be scored according to a given metric based on user actions as users interact with the corresponding three-dimensional environments, and supervised learning may then be used to train a graph neural network to predict the metric score for a given layout. By performing this training over a large number of layouts, the trained graph neural network may learn which layouts typically lead to a high metric score, and this information may be used to determine new layouts predicted to have a high score.

It is to be noted that, because the nodes of a graph structure can represent various characteristics of digital assets, it may not be necessary for each training example to include the same set of digital assets, or even overlapping sets of digital assets. Accordingly, data from many different environments including many different sets of digital assets may be used to train a machine learning model, resulting in large data sets.

It is to be noted that the use of a graph neural network is exemplary, and other machine learning models could be used for determining a spatial configuration or order for a set of digital assets. For example, a reinforcement learning agent may be trained to determine a layout or path between digital assets, using a reward signal corresponding to a metric score as discussed above. Alternatively, a generative model could be used to determine a layout or path between digital assets. For example, a generative graph neural network could be adversarially trained to mimic high-scoring layouts or paths of high-scoring sessions, optionally coupled with a regression network which predicts a metric score for the output of the generative graph neural network.

Although in the examples described above a machine learning model is used to directly determine a layout or path between digital assets, in other examples the inference engine 136 may use a machine learning model to update the relationship data 134, for example by updating values associated with edges in a graph database, as opposed to these values being updated using a rules-based method.

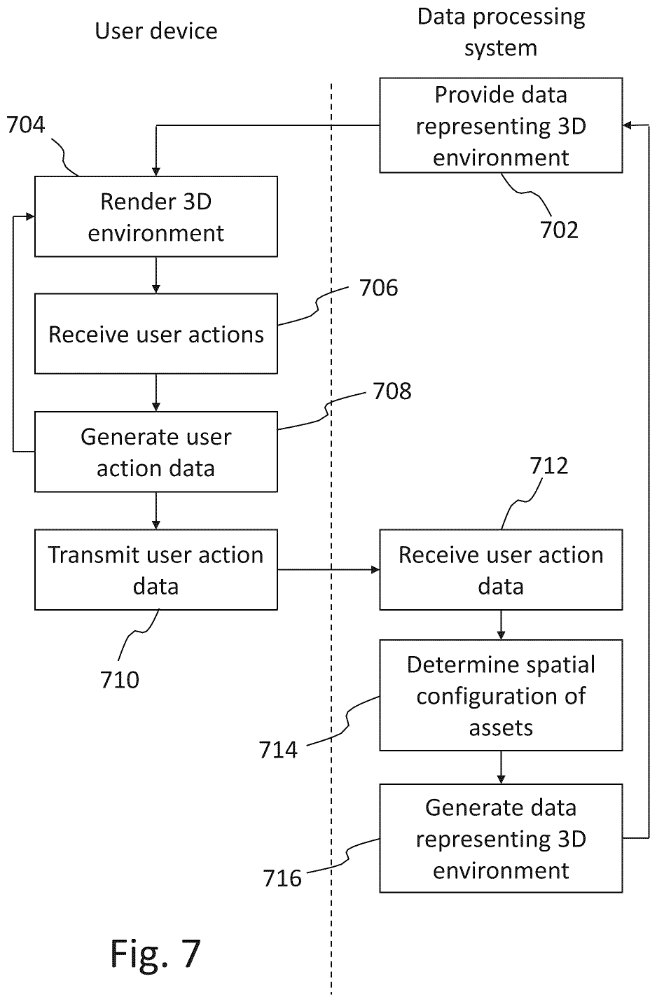

FIG. 7 shows an example of a method according to the present disclosure. The method proceeds with a data processing system providing, at 702, data representing a 3D environment to a set of user devices. The 3D environment includes a set of digital assets in a given spatial configuration. The data representing the 3D environment may include the individual assets and information on locations of the assets relative to a coordinate system. The data may further include data representing one or more models such as polygon meshes, and mapping data for mapping assets and/or other visual elements to one or more surfaces of the model(s). In some examples, a large image or texture such as a planogram may be mapped in its entirety to one or more surfaces of a polygon mesh. The one or more assets may for example be in the form of images or videos at one or more levels of detail. The 3D environment defined by the data may be static or may include one or more dynamic effects, such as dynamic lighting or motion effects.

In this example, the method continues with a user device rendering, at 704, the 3D environment on a display. The rendering may take place for example in a browser via Javascript, or within a dedicated application. The 3D environment may be rendered from a perspective of a virtual camera within a viewport which may include the whole or part of the available screen space of the display device. The 3D environment may include one or more models such as polygon meshes and mapping data for mapping assets and/or other visual elements to one or more surfaces of the polygon meshes. In some examples, a large image or texture such as a planogram may be mapped in its entirety to one or more surfaces of a polygon mesh. The 3D environment may be provided with one or more assets, for example in the form of images or videos at various levels of detail for rendering in dependence on a zoom level of the virtual camera. The 3D environment may be static or may include one or more dynamic effects, such as dynamic lighting or motion effects. The rendering may be performed using any appropriate rendering technique(s), such as rasterization and/or ray tracing. In other examples, the rendering may take place at the data processing system, in which case the data representing the 3D environment may simply include image frames depicting the rendered 3D environment.

Whilst rendering the 3D environment, the user device may receive, at 706, a user action via one or more input devices. The user actions may control aspects of the rendering of the 3D environment, such as the position and/or orientation of the virtual camera, and/or the angle subtended by the field of view of the virtual camera. Other examples of user actions may include clicks or other interactions with particular assets in the 3D environment.

The user device generates, at 708, user action data indicating the user actions received at 706 whilst rendering the 3D environment. The user action data may include a focal position associated with the user action, along with an indication of the type of user action. Other data may be included for specific types of user action, for example a direction of rotation in the case of a rotate action, enabling different rotations ending in the same focal position to be distinguished. The user action data may further indicate a zoom level from which the portion of the three-dimensional model falling within the viewport can be determined following the performing of the user action. In some cases, different levels of detail may be rendered in dependence on the zoom level (for example, different resolutions of images or different objects entirely), in which case the indicated zoom level may be used to determine what is actually visible on a given portion of the model.

The user device (or the data processing system) may continue to render the 3D environment, frame by frame, in dependence on user actions received from the one or more input devices. The user device may continue to generate user action data corresponding to the received user actions. The user device then transmits, at 710, the generated user action data to the data processing system. The user device may transmit the user action data in the form of individual events, with each event corresponding to an action, or may temporarily store the user action data for transmission in batches. In addition to the focal position, user action type, and other information discussed above, the user action data for a given user action may further indicate a time period between the given user action and the next user action. This may correspond to the time period for which the model appears stationary in the viewport of the user device, which may be relevant for determining user focus levels as explained hereinafter. In addition to the user action data, the user device may further transmit viewport data indicating viewport dimensions and/or a device type for each of the plurality of user devices. The user device may further transmit data identifying the 3D environment or a particular version of the 3D environment, such as a numerical model identifier and version identifier. This may be important for example if different 3D environments, or different versions of the 3D environment, are provided to different user devices at a given time. Different versions of a 3D environment may for example correspond to different arrangements of objects being mapped to a model's surface.

The data processing system receives, at 712, the user action data from the user device. User action data may be received from multiple user devices stored in log files corresponding to respective time periods prior to processing. Those skilled in the art will appreciate that other options are possible for storing user action data.

The data processing system determines, at 714, a new spatial configuration of assets in dependence on the user action data. The new spatial configuration of assets may include some or all of the digital assets from the 3D environment rendered at 704, and optionally may include other assets, for example assets from 3D environments sent to a different set of user devices. The new spatial configuration may be determined using any suitable method, such as one of the methods described above.

The data processing system generates, at 716, data representing a new 3D environment comprising digital assets arranged in accordance with the new spatial configuration determined at 714. The data may be in the same format as the data previously provided to the user device at 704. Following this, the method may return to 704, in which data representing the new 3D environment is provided or transmitted to a set of user devices (which may be the same or different to the set of user devices to which the previous 3D environment was provided and from which user action data was received) for rendering.

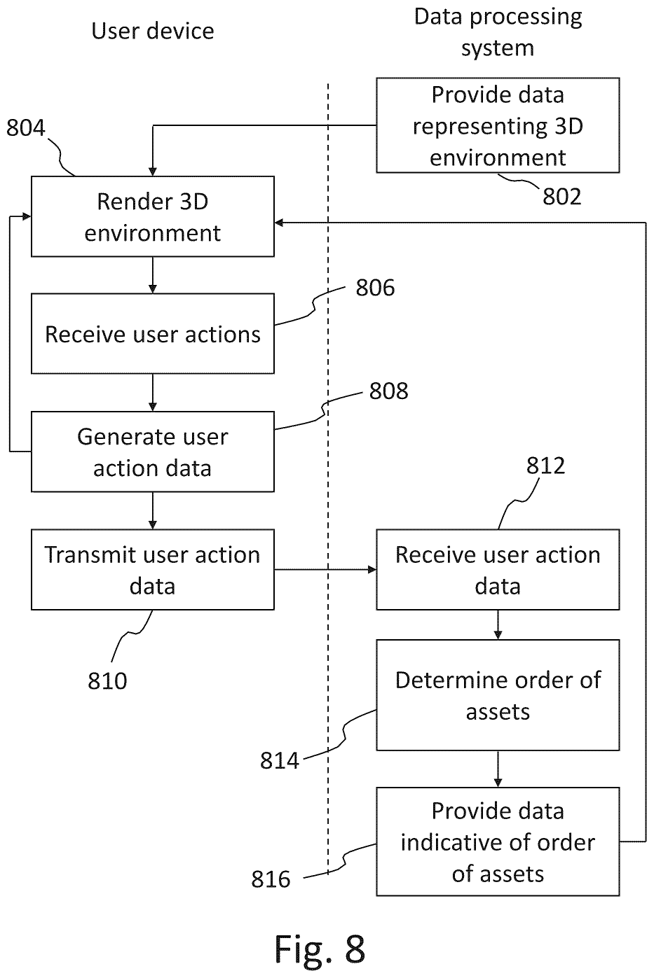

FIG. 8 shows a further example of a method according to the present disclosure. The steps 802-812 may substantially correspond to those of. However, in the example of FIG. 8, the rendering of the environment may take place at least in part from a perspective of a virtual camera moving along one or more predetermined paths between assets. A given path may include one or more branch points at which the path splits into multiple branches, such that different branches may be accessed in dependence on user input or other factors, as described in detail above.

The data processing system determines, at 814, an order of digital assets for future rendering, based on user action data received from one or more user devices at 808. The digital assets may include some or all of the digital assets on the predetermined paths previously used for rendering, and may optionally include other assets. The order of assets may be determined using any suitable method, such as one of the methods described above.

The data processing system may provide or transmit, at 816, data representing the determined order of digital assets to a set of user devices (which may be the same or different to the set of users from which user action data was received) for further rendering.

At least some aspects of the examples described herein with reference to FIGS. 1-8 comprise computer processes or methods performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A system comprising at least one processor, at least one memory, and a network interface, wherein the at least one memory comprises instructions which, when executed by the at least one processor, cause the at least one processor to carry out operations comprising:
providing, to a first one or more user devices via the network interface, data representing respective instances of a three-dimensional environment comprising a plurality of digital assets;
receiving, from the first one or more user devices via the network interface, input data indicating user actions performed at the first one or more user devices while the respective instances of the three-dimensional environment are rendered via the first one or more user devices, the input data indicating respective locations in the three-dimensional environment associated with the performing of the user actions; and
determining, in dependence on the indicated user actions and locations in the three-dimensional environment, a spatial configuration and/or an order for the plurality of digital assets, for use in rendering the plurality of digital assets via a second one or more user devices.

2. The system of claim 1, further comprising a user interface, wherein the operations comprise:
displaying, via the user interface, data indicative of the spatial configuration and/or order for the plurality of digital assets;
receiving, via the user interface, user input selecting the spatial configuration and/or order for the plurality of digital assets; and
rendering, dependent on the receiving of the user input, the plurality of digital assets via the second one or more user devices.

3. The system of claim 1, wherein the operations comprise determining, using the received input data, a spatial distribution of user focus in the three-dimensional environment,
wherein determining the spatial configuration and/or order for the plurality of digital assets is performed in dependence on the determined spatial distribution of user focus in the three-dimensional environment.

4. The system of claim 3, wherein the determining of the spatial distribution of user focus comprises allocating a measure of user focus to a region of the three-dimensional environment displayed to a user before and/or after the performance of a user action.

5. The system of claim 4, wherein the operations comprise:
receiving viewport data indicating viewport dimensions of at least one of the first one or more user devices; and
using the indicated viewport dimensions to infer the region of the three-dimensional environment displayed to the user before and/or after the user action is performed.

6. The system of claim 4, wherein:
for at least one of the first one or more user devices, the input data comprises data indicating time periods between successive user actions; and
the allocated measure of user focus increases with the indicated time period between the successive user actions.

7. The system claim 1, wherein:
the three-dimensional environment comprises a three-dimensional model upon which the plurality of assets are positioned;
the rendering via the first one or more user devices is from a perspective of a virtual camera;
for a given user action, the indicated location in the three-dimensional environment corresponds to a focal position on the three-dimensional model relating to a position and/or orientation of the virtual camera relative to the three-dimensional model following the user action.

8. The system of claim 7, wherein the user actions include at least one of:
a zoom action in which a field of view and/or distance of the virtual camera from the three-dimensional model is adjusted;
a move action in which a position and/or orientation of the virtual camera relative to the three-dimensional model is adjusted; and
a select action in which one of the plurality of digital assets is selected.

9. The system of claim 1, wherein the operations comprise:
determining a spatial configuration of the plurality of digital assets; and
generating a further three-dimensional environment comprising the plurality of digital assets positioned in accordance with the determined spatial configuration,
wherein the rendering via the second one or more user devices comprises rendering respective instances of the further three-dimensional environment.

10. The system of claim 9, wherein the operations comprise transmitting, to the second one or more user devices, data representing respective instances of the further three-dimensional environment,
wherein the rendering is performed at the second one or more user devices using the data representing the respective instances of the further three-dimensional environment.

11. The system of claim 1, wherein the operations comprise determining an order for the plurality of digital assets,
wherein the rendering via the second one or more user devices comprises rendering the three-dimensional environment from a perspective which moves automatically relative to the plurality of digital assets so as to present the plurality of digital assets in the determined order.

12. The system of claim 11, wherein the operations comprise transmitting, to the second one or more user devices, data indicative of the determined order for the plurality of digital assets,
wherein the rendering is performed at the second one or more user devices using the data indicative of the determined order for the plurality of digital assets.

13. The system of claim 1, wherein determining the spatial configuration and/or order for the plurality of digital assets is performed in dependence on context information associated with the rendering of the plurality of assets via the second one or more user devices.

14. The system of claim 13, wherein said context information is second context information, the method comprising storing first context information associated with the rendering of instances of the three-dimensional environment via the first one or more user devices, and
wherein determining the spatial configuration and/or order for the plurality of digital assets depends on a comparison between the first context information and the second context information.

15. The system of claim 1, wherein the operations comprise:
maintaining a graph database having a data structure comprising:
a plurality of nodes each associated with a respective one or more assets of the plurality of assets;
a plurality of edges for storing information about relationships between assets of the plurality of assets; and
updating the information stored by the plurality of edges based at least in part on the indicated locations in the three-dimensional environment,
wherein determining the spatial configuration and/or order for the plurality of digital assets is based on the information stored by the plurality of edges.

16. The system of claim 15, wherein determining the spatial configuration and/or order for the plurality of digital assets comprises processing data stored in the graph database using a graph neural network.

17. The system of claim 1, wherein the three-dimensional environment is a first three-dimensional environment, the user actions are first user actions, and the input data is first input data, the method further comprising:
providing, to a third one or more user devices, data representing respective instances of a second three-dimensional environment comprising at least some of the plurality of digital assets; and
receiving, from the third one or more user devices, second input data indicating second user actions performed at the third one or more user devices while respective instances of the second three-dimensional environment are rendered via the third one or more user devices, the second input data indicating respective locations in the second three-dimensional environment associated with the performing of the second user actions,
wherein the determining of the spatial configuration and/or order for the plurality of digital assets further is further based on the second input data.

18. The system of claim 1, wherein the determining of the spatial configuration and/or order for the plurality of digital assets is dependent on user actions performed while the plurality of assets are rendered via the second one or more user devices.

19. A computer-implemented method comprising:
providing, to a first one or more user devices via the network interface, data representing respective instances of a three-dimensional environment comprising a plurality of digital assets;
receiving, from the first one or more user devices via the network interface, input data indicating user actions performed at the first one or more user devices while the respective instances of the three-dimensional environment are rendered via the first one or more user devices, the input data indicating respective locations in the three-dimensional environment associated with the performing of the user actions; and
determining, in dependence on the indicated user actions and locations in the three-dimensional environment, a spatial configuration and/or an order for the plurality of digital assets, for use in rendering the plurality of digital assets via a second one or more user devices.

20. One or more non-transitory storage media comprising instructions which, when executed by a computer, cause the computer to carry out a method comprising:
providing, to a first one or more user devices via the network interface, data representing respective instances of a three-dimensional environment comprising a plurality of digital assets;
receiving, from the first one or more user devices via the network interface, input data indicating user actions performed at the first one or more user devices while the respective instances of the three-dimensional environment are rendered via the first one or more user devices, the input data indicating respective locations in the three-dimensional environment associated with the performing of the user actions; and
determining, in dependence on the indicated user actions and locations in the three-dimensional environment, a spatial configuration and/or an order for the plurality of digital assets, for use in rendering the plurality of digital assets via a second one or more user devices.
